(19) United States
(12) Patent Application Publication
(10) Pub. No.: US 2025/0385417 A1
(43) Pub. Date: Dec. 18, 2025

(54) IMPEDANCE TRANSFORMER WITH NON-COUPLED TRANSMISSION LINE PATHS FOR HIGH FREQUENCY OPERATION

(71) Applicant: Innovative Power Products, Inc., Holbrook, NY (US)

(72) Inventor: Thomas J. Dowling, Port Jefferson, NY (US)

(21) Appl. No.: 19/240,783

(22) Filed: Jun. 17, 2025

Related U.S. Application Data
(60) Provisional application No. 63/660,841, filed on Jun. 17, 2024.

(51) Int. Cl. H01P 3/08

(52) U.S. Cl. CPC H01P 3/08

(57) ABSTRACT

An impedance transformer is provided. The impedance transformer may comprise a substrate, an input and output port. A non-coupled transmission line path may be mounted within the substrate and extend along the substrate between the input and output port. The non-coupled transmission line path may comprise a plurality of transmission lines connected in series. At least one transmission line is a parallel combination of two transmission lines.

### CROSS-REFERENCE TO RELATED APPLICATION

This application claims the benefit of U.S. Provisional Application No. 63/660,841 filed on Jun. 17, 2024, the entire contents of which are incorporated herein by reference.

### BACKGROUND

By using transmission lines in place of windings, transmission line impedance transformers are able to operate at high frequencies and across wide bandwidths. Transmission line impedance transformers are very useful for matching radio frequency (RF) and microwave sources and loads of different impedances.

### SUMMARY

The present application provides an impedance transformer comprising a substrate and a non-coupled transmission line path. The non-coupled transmission line path is mounted within the substrate and extends along the substrate between an input port and an output port. The non-coupled transmission line path comprises a plurality of transmission lines connected in series. At least one transmission line of the plurality of transmission lines is a parallel combination of two transmission lines. In an example, the non-coupled transmission line path is configured to operate in a frequency bandwidth range of about 100 MHz to 6000 MHz.

An impedance transformer comprising:
a multi-layer substrate comprising:
a first transmission line path mounted within a first layer of the multi-layer substrate and extending along the substrate between an input port and an output port, the first transmission line path comprising a plurality of first transmission lines connected in series, wherein at least one transmission line of the first transmission line path is a parallel combination of two transmission lines; and
a second transmission line path mounted within a second layer of the multi-layer substrate and extending along the substrate between the input port and the output port, the second transmission line path comprising a plurality of second transmission lines connected in series, wherein at least one transmission line of the second transmission line path is a parallel combination of two transmission lines; and
at least one via connecting the first transmission line path and the second transmission line path between the first layer and the second layer.

The present application provides an impedance transformer comprising a non-coupled transmission line path configured to operate in a frequency bandwidth range of about 100 MHz to 6000 MHz.

### BRIEF DESCRIPTION OF THE DRAWINGS

FIG. 1 is a perspective view of an example impedance transformer according to an embodiment of the present application.

FIG. 2 is an exploded view of the example impedance transformer shown in FIG. 1.

FIG. 3 is a top sectional view of the example impedance transformer shown in FIG. 1.

FIG. 4 is a block flow diagram illustrating an example of electromagnetic wave propagation through the example impedance transformer shown in FIG. 1.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

Impedance matching is an important aspect in the design of microwave and millimeter wave circuits. A good impedance match ensures an efficient transfer of power from the source to the load. Conversely, a mismatch between the load and source results in reflections that degrade the system signal to noise ratio (SNR) and causes the sensitivity of the device to deteriorate. The reflections generate a standing wave along the transmission line. Standing waves are problematic in high power applications because they lead to relatively high currents at certain spots along the transmission line. As those skilled in the art will appreciate, the current is dissipated as heat in accordance with the relationship IR, where I is the current and R is the resistance of the transmission line. The extraordinary heat created at these so-called “hot spots” becomes a reliability issue since the overheating reduces the lifetime of the device. Briefly stated, a good impedance match ensures the signal power is transmitted to the RF load instead of being dissipated as heat.

Examples of impedance transformers include coupled transmission line paths (e.g., edge-coupled strip-line paths) and non-coupled transmission line paths (i.e., transmission line paths not coupled to another transmission line path). For example, impedance transformers having edge-coupled transmission line paths include two conductors placed side-by-side on the edge of a dielectric substrate. Impedance transformers having non-coupled transmission line paths typically may include traces mounted with a printed circuit board (PCB) material, sandwiched between two reference planes in which the trace is exposed to the dielectric material.

In some applications, it is useful to provide low cost, high power, planer, impedance transformers for matching RF and microwave sources and loads of different impedances while also operating in a wide frequency bandwidth. But achieving an efficient (e.g., low cost, small size) impedance transformer having a good impedance match over a wide frequency band is challenging.

For example, while coupled transmission line paths facilitate a reduction in size of a transformer, they have a limited bandwidth (i.e., limited to about 700 MHz to 2700 MHZ) and have more signal loss (e.g., reduced signal-to-noise ratio and cross-interference) compared to non-coupled transmission line paths. The different transmission lines of a conventional non-coupled transmission line path can be used for different frequencies. However, these conventional non-coupled transmission line paths are often too wide and/or long to meander in the space available on the layer of the PCB.

Features of the present application include an efficient (low cost, small sized) impedance transformer having a good impedance match (e.g., 50 Ohms to 25 Ohms, 50 Ohms to 12.5 Ohms and 50 Ohms to 6.25 Ohms) over a frequency band (e.g., 100 MHz to 6000 MHz or higher).

Features of the present application include an impedance transformer comprising at least one non-coupled transmission line path. The non-coupled transmission line path is configured (e.g., routed) such that the spacing between a transmission line and other transmission lines of the transmission line path is reduced and the transmission line path is meandered along the PCB material to maintain the overall smaller size of the PCB. The configuration of the non-coupled transmission line path enables the transformer to provide good impedance matching over a wider frequency band than conventional non-coupled transmission line transformers, while maintaining a smaller overall transformer size. For example, the spacing between transmission lines reduces electromagnetic coupling between the adjacent transmission lines while maintaining a smaller overall transformer size. Wider transmission lines need larger spaces while thinner lines can use smaller spaces.

The transmission lines, of a transmission line path, which are used to match higher impedances (i.e., higher impedance transmission lines) are routed in series along the PCB. However, because transmission lines of the transmission line path which are used to match lower impedances (i.e., lower impedance transmission lines) are typically too wide to meander in the space available on the PCB, the transmission lines of the transmission line path used to match lower impedances (i.e., lower impedance transmission lines) are split up as two higher impedance transmission lines in parallel with each other. This series and parallel configuration of the transmission lines of various impedances provide the transformation to match the input and output impedances while maintaining a smaller overall transformer size.

The electrical length of the transmission line transformers are typically 90 degrees at the center frequency of the bandwidth. The number of 90 degree transmission lines used along the transmission line path is determined as a function of the difference between the input impedance and output impedance being matched and the target bandwidth (e.g., target bandwidth range). For example, more transmission lines are used for larger target bandwidth ranges and larger input and output impedances.

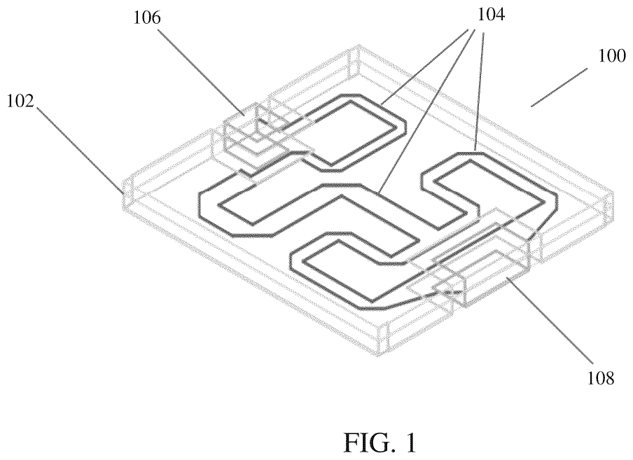

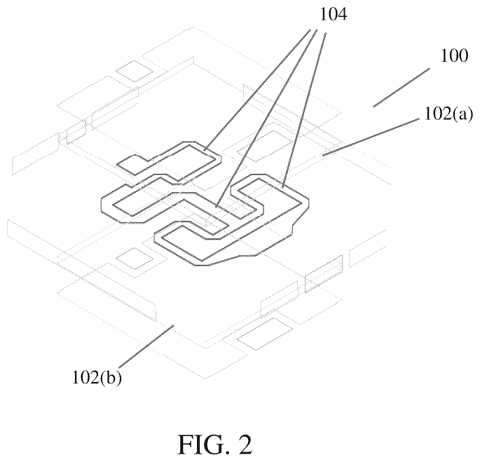

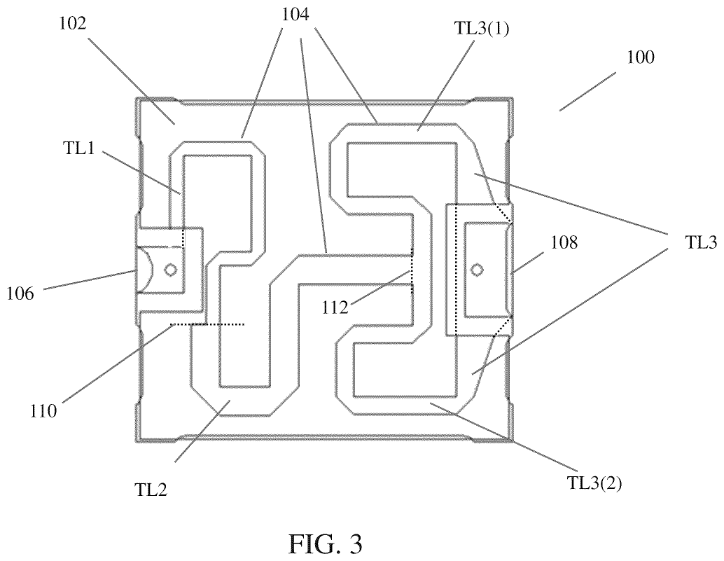

FIG. 1 is a perspective view of an example impedance transformer 100 according to an embodiment of the present application. FIG. 2 is an exploded view of the example impedance transformer shown in FIG. 1. FIG. 3 is a top sectional view of the example impedance transformer shown in FIG. 1. The example impedance transformer 100 is now described together with reference to FIGS. 1-3.

As shown in FIGS. 1 and 2, the impedance transformer 100 includes a transmission path 104, formed within a substrate 102 (e.g., PCB material) and extending between input port 106 and output port 108. The substrate 102 can be any well-known dielectric material used in the integrated circuit fabrication industry (e.g., laminates, ceramics or other dielectric material having a low dielectric constant to reduce dielectric leakage).

As shown in FIG. 3, the non-coupled transmission path 104 comprises a plurality of transmission lines of various impedances (TL1, TL2, and TL3) within substrate 102, which may include one or more layers laminated together to create a surface mount part. The transmission lines (TL1, TL2, and TL3 are, for example, copper (e.g., etched from PCB material), with one or more transmission lines (e.g., outside transmission lines) being plated (e.g., tin plated) to facilitates a higher frequency operation than conventional transmission lines, (e.g., coax ferrite transmission lines, which are typically used for lower frequencies and are limited to specific impedance transformations).

The non-coupled transmission line path 104 is configured (e.g., routed) such that the spacing between a transmission line (TL1, TL2, and TL3) and other transmission lines of the transmission line path 104 is reduced and meandered along the substrate 102 to maintain the smaller size. The routing of the non-coupled transmission lines enables the transformer to provide good impedance matching over a wider frequency band than conventional transformers.

For example, as shown in FIGS. 1 and 2, the non-coupled transmission line path 104 is mounted within the substrate 102 (between 2 layers 102(a) and 102(b) of substrate 102) and extends along the substrate 102 between the input port and the output port 108. The non-coupled transmission line path 104 comprises 3 transmission lines TL1, TL2 and TL3 connected in series along the substrate 102. Transmission line TL1 is connected between input port 106 and transmission line TL2. The dashed line 110 shows the location where transmission lines TL1 and TL2 are connected to each other. Transmission line TL2 is connected between transmission line TL1 and transmission line TL3. The dashed line 112 shows the location where transmission lines TL2 and TL3 are connected to each other.

As further shown in FIG. 3, transmission line TL3 is a parallel combination of two transmission lines TL3(1) and TL3(2). That is, because transmission lines used to match lower impedances are often too wide to meander in series within the space available along a substrate, transmission line TL3 is instead split up as two higher impedance lines in parallel with each other. That is, the wider lower impedance transmission line TL3 (used to match a lower impedance) is split into thinner (less wide) transmission lines TL3(1) and TL3(2) (used to match lower impedances than TL3), which are connected in parallel with each other between transmission line TL2 and output port 108. The series and parallel configuration of the transmission lines of various impedances are used to provide the transformation to match the input and output impedances while maintaining a smaller overall transformer size.

Transmission lines TL1 and TL2 are each configured to match a different impedance. Accordingly, the thickness of transmission line TL1 is different from transmission line TL2 (e.g., less than the thickness of transmission line TL2 in FIG. 2). Transmission lines TL3(1) and TL3(2) are also each configured to match a same impedance, but in a higher impedance range than the impedance range of transmission lines TL1 and TL2.

The electrical length of transmission line transformers are typically 90 degrees at the center frequency of the bandwidth. The number of 90 degree transmission lines used along the transmission line path is determined as a function of the difference between the input impedance and output impedance being matched and the target bandwidth (e.g., target bandwidth range). For example, more transmission line transformers are used for larger target bandwidth ranges and larger input and output impedances.

The number shape of the transmission lines, and the routing of the transmission lines shown in FIGS. 1-3 is merely an example. Features of the present disclosure can include any number of transmission lines (including transmission lines split into parallel combinations of transmission lines) having different shapes (e.g., lengths and widths) and routing than the transmission lines shown in FIGS. 1-3.

The impedance transformer 100 in the example shown in FIGS. 1-3 operates over a wide frequency band 1000 MHz to 3000 MHz. Features of the present disclosure can be implemented to operate over a wider frequency band, such as for example 100 MHz to 6000 MHz or higher.

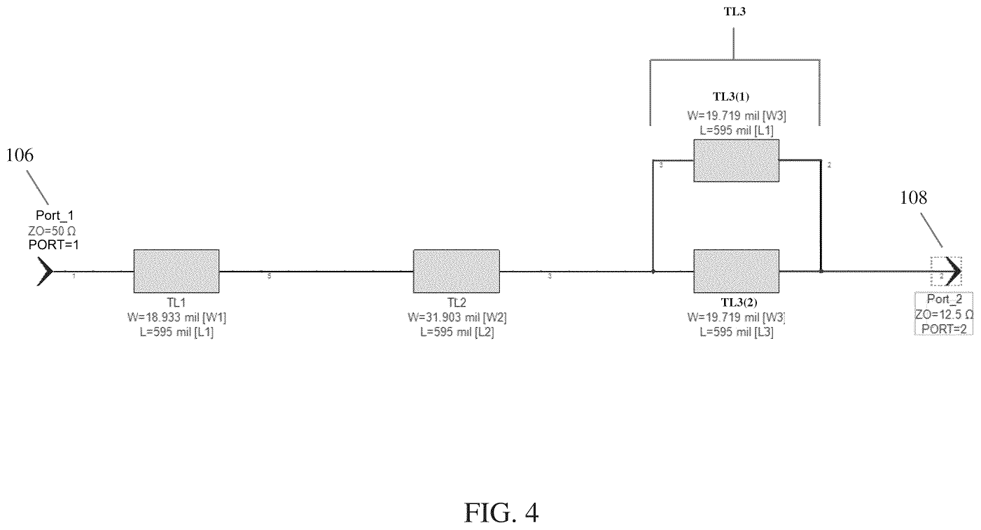

FIG. 4 is a block flow diagram illustrating an example of electromagnetic wave propagation through the example impedance transformer 100 shown in FIG. 1.

As shown in FIG. 4, an electromagnetic wave propagates from input port 106, having an impedance of 50 Ohms, along transmission line TL1, having an example width of 18.933 mm and a length of 595 mm which is configured to match a first target impedance. The electromagnetic wave then propagates along transmission line TL2, having an example width of 31.903 mm and the same length of 595 mm which is configured to match a second target impedance. The electromagnetic wave then propagates from transmission line TL2, in parallel along transmission lines TL3(1) and TL3(2), to output port 108 having an output impedance of 12.5 Ohms. Both transmission lines TL3(1) and TL3(2) have an example width of 19.719 mm and an example length of 595 mm which is configured to match a third target impedance.

The drawings show one transmission line path mounted in a multi-layer substrate in the center of a transformer device and a copper ground plane on the top, bottom and sides of the device. Features of the present application can, however, include transmission line paths mounted on multiple layers of the multi-layer substrate. For example, the transformer device may include, from top to bottom: a first ground conductor; a first insulator; a first transmission line; a first substrate layer; a second ground conductor; a second insulator; a second transmission line; a second substrate layer; and a third ground conductor. The transformer device also includes vias connecting the first and second transmission lines between the first and second layers.

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. An impedance transformer comprising:
a substrate;
an input port;
an output port; and
a non-coupled transmission line path mounted within the substrate and extending along the substrate between the input port and the output port, the non-coupled transmission line path comprising a plurality of transmission lines connected in series, wherein at least one transmission line of the plurality of transmission lines is a parallel combination of two transmission lines.

2. The impedance transformer of claim 1, wherein the non-coupled transmission line path is configured to operate in a frequency bandwidth range of about 100 MHz to 6000 MHz.

3. The impedance transformer of claim 1, wherein the plurality of transmission lines comprises a first transmission line and a second transmission line, the second transmission line is connected in series with the first transmission line, where a width of the second transmission line is different from a width of the first transmission line.

4. The impedance transformer of claim 3, wherein a length of the second transmission line is a same as a length of the first transmission line.

5. The impedance transformer of claim 4, wherein the length and the width of the first transmission line is configured to a match a first target impedance.

6. The impedance transformer of claim 4, wherein the length and the width of the second transmission line is configured to a match a second target impedance.

7. The impedance transformer of claim 1, wherein each of the two transmission lines which comprise the parallel combination has a same length and width.

8. The impedance transformer of claim 7, wherein the length and width of each of the two transmission lines is configured to collectively match a target impedance.

9. The impedance transformer of claim 1, wherein the input port and the output port have different impedances.

10. The impedance transformer of claim 3, wherein the first transmission line comprises a plurality of portions, each portion having an extending length, where the extending length of adjacent portions are substantially orthogonal to each other, such that the first transmission line meanders within the substrate.

11. The impedance transformer of claim 10, wherein the second transmission line comprises a plurality of portions, where a first portion of the second transmission line is connected to a terminus portion of the first transmission line and extends in an extending length in a same direction, where the extending length of adjacent portions of the second transmission line are substantially orthogonal to each other, such that the second transmission line meanders within the substrate.

12. The impedance transformer of claim 11, wherein each of the two transmission lines which comprise the parallel combination comprises a plurality of portions, where a first portion of each of the two transmission lines is connected to a terminus portion of the second transmission line and extends in an extending length in a direction substantially orthogonal to the extending length of the terminus portion of the second transmission line.

13. The impedance transformer of claim 1, wherein one or more of the plurality of transmission lines are plated.

14. The impedance transformer of claim 13, wherein the plating comprises tin.

15. An impedance transformer comprising:
a multi-layer substrate comprising:
a first transmission line path mounted within a first layer of the multi-layer substrate and extending along the substrate between an input port and an output port, the first transmission line path comprising a plurality of first transmission lines connected in series, wherein at least one transmission line of the first transmission line path is a parallel combination of two transmission lines; and
a second transmission line path mounted within a second layer of the multi-layer substrate and extending along the substrate between the input port and the output port, the second transmission line path comprising a plurality of second transmission lines connected in series, wherein at least one transmission line of the second transmission line path is a parallel combination of two transmission lines; and
at least one via connecting the first transmission line path and the second transmission line path between the first layer and the second layer.
